(19) United States
(12) Patent Application Publication
(10) Pub. No.: US 2026/0101055 A1
(43) Pub. Date: Apr. 9, 2026

(54) RESOLUTION-EXPANDABLE NEURAL NETWORK FOR GENERATIVE VIDEO COMPRESSION

(71) Applicant: Alibaba (China) Co., Ltd., Hangzhou (CN)

(72) Inventors: Shanzhi YIN, Kowloon Tong (HK); Bolin CHEN, Kowloon Tong (HK); Yan YE, San Diego, CA (US)

(21) Appl. No.: 19/323,240

(22) Filed: Sep. 9, 2025

Related U.S. Application Data
(60) Provisional application No. 63/705,037, filed on Oct. 9, 2024.

(51) Int. Cl. H04N 19/42; H04N 19/132; H04N 19/137; H04N 19/172; H04N 19/184

(52) U.S. Cl. CPC H04N 19/42; H04N 19/132; H04N 19/137; H04N 19/172; H04N 19/184

(57) ABSTRACT

A video decoding method includes: decoding an image bitstream associated with a video sequence to reconstruct a key frame of the video sequence and obtain extracted features of the reconstructed key frame; decoding a feature bitstream associated with the video sequence to obtain extracted features of one or more inter frames of the video sequence; obtaining motion information and occlusion information based on the extracted features of the reconstructed key frame and the extracted features of the one or more inter frames; resampling, by a neural network, the reconstructed key frame based on the motion information and occlusion information by a neural network; and reconstructing, by the neural network, the video sequence based on the resampled reconstructed key frame. A network width and a network depth of the neural network is adjusted in response to an input resolution.

### CROSS-REFERENCE TO RELATED APPLICATIONS

This application claims priority to U.S. Provisional Application No. 63/705,037, titled “RESOLUTION-EXPANDABLE GENERATOR FOR GENERATIVE VIDEO COMPRESSION,” filed on Oct. 9, 2024, which is hereby incorporated by reference in its entirety.

### TECHNICAL FIELD

The present disclosure generally relates to video processing, and more particularly, to a resolution-expandable generator (e.g., generative neural network) for generative video compression.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY

According to some embodiments, a video decoding method includes: decoding an image bitstream associated with a video sequence to reconstruct a key frame of the video sequence and obtain extracted features of the reconstructed key frame; decoding a feature bitstream associated with the video sequence to obtain extracted features of one or more inter frames of the video sequence; obtaining motion information and occlusion information based on the extracted features of the reconstructed key frame and the extracted features of the one or more inter frames; resampling, by a neural network, the reconstructed key frame based on the motion information and occlusion information; and reconstructing, by the neural network, the video sequence based on the resampled reconstructed key frame. A network width and a network depth of the neural network is adjusted in response to an input resolution.

According to some embodiments, a video encoding method includes: encoding an image bitstream comprising coded information for a key frame of a video sequence, wherein the image bitstream is decodable to reconstruct the key frame; and encoding a feature bitstream comprising coded information for extracted features of one or more inter frames of the video sequence. Features of a reconstructed key frame and the features of the one or more inter frames encoded in the feature bitstream are used to generate dense motion information and occlusion information for resampling the reconstructed key frame by a neural network. The neural network reconstructs the video sequence by adjusting a network width and a network depth in response to an input resolution.

According to some embodiments, a method of storing an image bitstream and a feature bitstream includes: generating an image bitstream and a feature bitstream based on a video sequence, wherein the image bitstream comprises coded information for reconstructing a key frame of the video sequence and obtaining extracted features of the reconstructed key frame, and the feature bitstream comprises coded information for obtaining extracted features of one or more inter frames of the video sequence; and storing the image bitstream and the feature bitstream in at least one non-transitory computer-readable medium. The video sequence is to be reconstructed by a neural network that resamples the reconstructed key frame. The neural network adjusts a network width and a network depth in response to an input resolution.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating an example encoding-decoding process of generative video coding (GVC) algorithms, according to some embodiments of the present disclosure.

FIG. 2 illustrates a schematic diagram of an example framework for video compression in a video coding system, according to some embodiments of the present disclosure.

FIG. 3 is a schematic diagram illustrating an example architecture of an end-to-end Deep-based Video Compression (DVC) framework, according to some embodiments of the present disclosure.

FIG. 4 is a block diagram of an example apparatus for encoding or decoding image data, according to some embodiments of the present disclosure.

FIG. 5 is a schematic diagram illustrating a basic framework of the deep-based video generative compression scheme based on First Order Motion Model (FOMM), according to some embodiments of the present disclosure.

FIG. 6 is a schematic diagram illustrating an encoder of a deep-based video generative compression scheme based on Compact Feature Temporal Evolution (CFTE), according to some embodiments of the present disclosure.

FIG. 7 is a schematic diagram illustrating a decoder of a deep-based video generative compression scheme based on Compact Feature Temporal Evolution (CFTE), according to some embodiments of the present disclosure.

FIG. 8 is a schematic diagram illustrating an example network structure 800 of a resolution-expandable neural network, according to some embodiments of the present disclosure.

FIG. 9 is a schematic diagram illustrating an example generative video coding system with a resolution-expandable neural network, according to some embodiments of the present disclosure.

FIG. 10 is a flowchart for an example method for decoding a bitstream, according to some embodiments of the present disclosure.

FIG. 11 is a flowchart for an example method for encoding a bitstream, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

In the era of artificial intelligence generated content (“AIGC”), video coding techniques are rapidly developed towards more intelligent, immersive and interactive applications scenarios. One of key techniques is generative video coding (GVC), which exploits strong inference capabilities of deep generative models for visual data compression and achieves superior Rate-Distortion (RD) performance compared to conventional hybrid codecs such as High Efficiency Video Coding (HEVC) and Versatile Video Coding (VVC). For example, some generative video codecs are evolved from deep image animation methods, which characterize the input high-dimensional visual signal into compact representations and employ the powerful deep generative model to achieve high-quality signal reconstruction/animation. For example, Deep Animation Codec utilizes 2D key-point representation for ultra-low bit-rate video conferencing. Similarly, 3D key-point is leveraged in talking-face video coding for free-view control, while feature matrices can represent facial temporal trajectory in a more compact manner.

The Joint Video Experts Team (JVET) of the ITU-T Video Coding Expert Group (ITU-T VCEG) and the ISO/IEC Moving Picture Expert Group (ISO/IEC MPEG) are currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve this goal, since 2015, the JVET has been developing technologies beyond HEVC using the joint exploration model (JEM) reference software. As coding technologies being incorporated into the JEM, the JEM achieved substantially higher coding performance than HEVC. In October 2017, a joint call for proposals (CfP) was issued by VCEG and MPEG to formally start the development of next generation video compression standard beyond HEVC. Responses to the CfP were evaluated at the JVET meeting in San Diego in April 2018, and the formal development process of the VVC standard started in April 2018.

The VVC standard has been progressing well since April 2018, and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

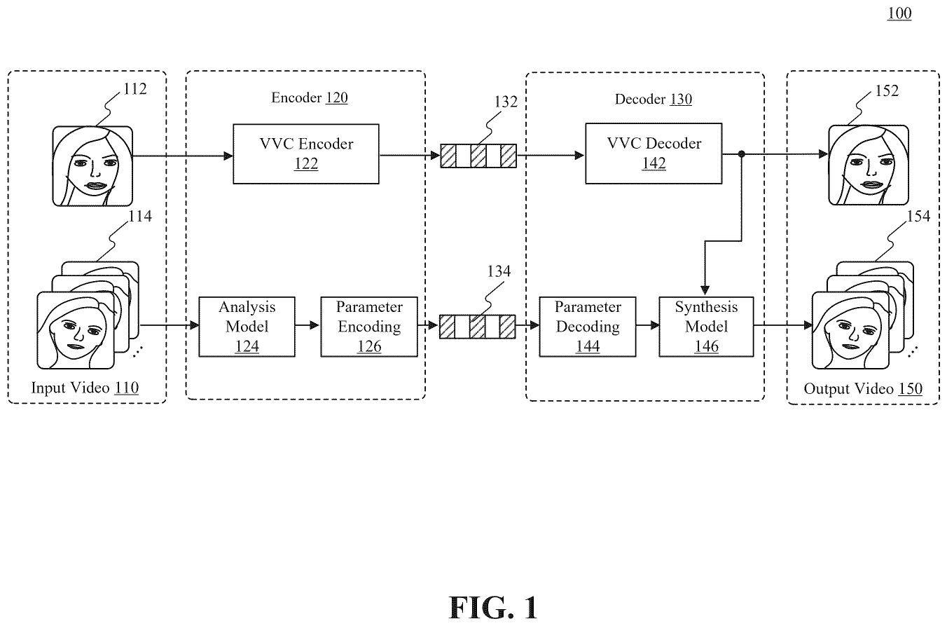

FIG. 1 is a schematic diagram illustrating an example encoding-decoding process of generative video coding (GVC) algorithms, according to some embodiments of the present disclosure. For example, the encoding-decoding process can be used for generative face video coding. As shown in FIG. 1, a generative video coding system 100 may be configured to compress and reconstruct an input video sequence 110 having a key-reference frame 112 and one or more inter frames 114 following the key-reference frame 112. In some embodiments, the generative video coding system 100 may include an encoder 120 and a decoder 140, each including multiple interconnected components designed to process video data efficiently. In some cases, the generative video coding system 100 may utilize both VVC coding techniques and advanced generative models to achieve flexible resolution outputs.

The encoder 120 of the generative video coding system 100 may process input video frames to generate an image bitstream 132 associated with the key-reference frame 112 and a feature bitstream 134 associated with inter frames 114. The decoder 130 of the generative video coding system 100 may then use the image bitstream 132 and the feature bitstream 134 to reconstruct the video sequence to obtain the output video 150 including the decoded key-reference frame 152 and the reconstructed inter frames 154. As shown in FIG. 1, in the encoder 120, the key-reference frame 112 of the video can be compressed by using various image/video codec, such as Advanced Video Coding (AVC), High Efficiency Video Coding (HEVC), and Versatile Video Coding (VVC). In the embodiments in FIG. 1, VVC encoder 122 is configured to code the key-reference frame 112 into the image bitstream 132. The subsequent inter frames 114 can be characterized with the compact transmitted symbols and coded into the feature bitstream 134 by using an analysis model 124 and a parameter encoding module 126 in the encoder 120.

At the decoder side, the decoder 130 may decode, by using a VVC decoder 142, the image bitstream 132 to obtain the decoded key-reference frame 152. In addition, the decoder 130 may decode, by a corresponding parameter decoding module 144 the feature bitstream 134 to obtain compact facial information. The decoded key-reference frame 152 and the compact facial information are jointly fed into a synthesis model 146 to obtain the reconstructed inter frames 154 for reconstructing the video. In this manner, video communication can be actualized towards ultra-low bitrate and high-quality reconstruction.

In some embodiments, the capability of generative coding illustrated in FIG. 1 may be limited by feature designs and generation schemes. For example, the generative video codecs mainly use explicit feature representation with actual physical manifestation, causing unnecessary compression redundancy. Meanwhile, such representations may lack expressability and generalizability to handle complicated scenarios such as moving human body. For example, explicit features including landmarks, key-points, and segmentation maps are implemented for low-bandwidth video chat compression. In some embodiments, different feature representations may lead to different amounts of bandwidth requirement.

Video compression standards, such as AVC, HEVC, and VVC, are developed to achieve compression performance. In these standards, a block-based hybrid video coding framework can be used to exploit the spatial redundancy, temporal redundancy and information entropy redundancy in the video.

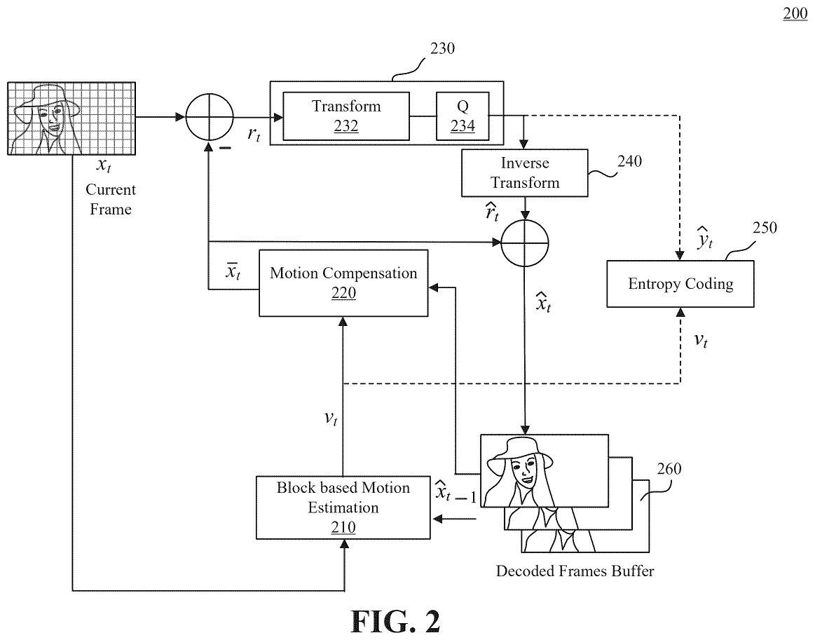

FIG. 2 illustrates a schematic diagram of an example framework 200 for video compression in a video coding system, according to some embodiments of the present disclosure. Generally, the video compression encoder generates the bitstream based on the input current frames. And the decoder reconstructs the video frames based on the received bitstreams. The framework 200 in FIG. 2 follows the predict-transform architecture.

The input video is processed block by block. Specifically, the input frame xₜ is split into a set of blocks, e.g., square regions, of the same size (e.g., 8×8). The encoding procedure of the video compression algorithm in the encoder side will be discussed as follows.

The input frame xₜ is processed by a block-based motion estimation module 210 configured to estimate the motion between the current frame xₜ and a previous reconstructed frame \hat{x}ₜ₋₁. Based on the input frame xₜ and the previous reconstructed frame \hat{x}ₜ₋₁, the block-based motion estimation module 210 outputs a corresponding motion vector vₜ for each block. Then, the corresponding motion vector vₜ is processed by a motion compensation module 220 in order to obtain a predicted frame x̅ₜ by copying the corresponding pixels in the previous reconstructed frame \hat{x}ₜ₋₁, to the current frame based on the motion vector vₜ defined in the motion estimation module 210. Accordingly, a residual rₜ between the original frame xₜ and the predicted frame x̅ₜ is obtained as rₜ=xₜ−x̅ₜ. In some embodiments, the motion compensated prediction performed above is also known as an “inter prediction,” “inter-picture prediction,” or “temporal prediction.”

After the residual rₜ is generated, the encoder can feed the residual rₜ to a transform stage 232 and a quantization stage 234 in a transform and quantization module 230 to generate quantized result ŷₜ. In some embodiments, a linear transform (e.g., DCT) can be used before the quantization for better compression performance. Different transform algorithms can use different base patterns. Various transform algorithms can be used at transform stage 232, such as, for example, a discrete cosine transform, a discrete sine transform, or the like. The transform at transform stage 232 is invertible. That is, the encoder can restore the residual rₜ by an inverse operation of the transform (referred to as an “inverse transform”) performed by an inverse transform module 240. For a video coding standard, the encoder and a corresponding decoder can use the same transform algorithm (thus the same base patterns). Thus, the encoder can record only the transform coefficients, from which a decoder can reconstruct the residual rₜ without receiving the base patterns from the encoder.

The encoder can further compress the transform coefficients at quantization stage 234. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 234, the encoder can generate quantized residual coefficients ŷₜ by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized residual coefficients ŷₜ, by which the transform coefficients are further compressed. The quantization process is also invertible, in which quantized residual coefficients ŷₜ can be reconstructed to the transform coefficients in an inverse operation of the quantization (referred to as “inverse quantization”).

Because the encoder disregards the remainders of such divisions in the rounding operation, the quantization stage 234 can be lossy. Typically, quantization stage 234 can contribute the most information loss in the encoding process. The larger the information loss is, the fewer bits the quantized residual coefficients ŷₜ can need. For obtaining different levels of information loss, the encoder can use different values of the quantization parameter or any other parameter of the quantization process.

The encoder can feed the motion vector vₜ and quantized residual coefficients t to a binary coding module 250 to generate the bitstream to complete a forward path. By the binary coding module 250, the encoder can encode the motion vector vₜ and quantized residual coefficients ŷₜ using a binary coding technique, such as, for example, entropy coding, variable length coding, arithmetic coding, Huffman coding, context-adaptive binary arithmetic coding (CABAC), or any other lossless or lossy compression algorithm. Accordingly, the motion vector vₜ and the quantized residual coefficients ŷₜ can be encoded into bits by an entropy coding method and sent to the decoder.

As explained above, by the inverse transform module 240, the quantized result ŷₜ can be used for obtaining the reconstructed residual ft by the inverse transform. During the process, after quantization stage 234, the encoder can feed quantized residual coefficients ŷₜ to an inverse quantization stage and an inverse transform stage in the inverse transform module 240 to generate reconstructed residual \hat{r}ₜ. At the inverse quantization stage, the encoder can perform inverse quantization on quantized residual coefficients ŷₜ to generate reconstructed transform coefficients. At the inverse transform stage, the encoder can generate the reconstructed residual \hat{r}ₜ based on the reconstructed transform coefficients. Then, the encoder can add the reconstructed residual \hat{r}ₜ to the predicted frame x̅ₜ to obtain the reconstructed frame \hat{x}ₜ to be used for the next iteration of process, i.e., \hat{x}ₜ=\hat{r}ₜ+x̅ₜ. The reconstructed frame \hat{x}ₜ will be used by the (t+1)ₜₕ frame in the motion estimation module 210 for the motion estimation.

After generating the reconstructed frame \hat{x}ₜ, the encoder can apply a loop filter to the reconstructed frame \hat{x}ₜ to reduce or eliminate distortion (e.g., blocking artifacts) introduced by the inter prediction. In some embodiments, the encoder can apply various loop filter techniques at the loop filter stage, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in a decoded frames buffer 260 for later use (e.g., to be used as an inter-prediction reference frame for a future frame of the video sequence). The encoder can store one or more reference frames in the buffer 260 to be used for inter prediction. In some embodiments, the encoder can encode parameters of the loop filter (e.g., a loop filter strength) at the coding stage, along with the motion vector vₜ and quantized residual coefficients ŷₜ, and other information. The encoder can perform the process discussed above iteratively to encode each frame of the video sequence.

For the decoder, based on the bits provided by the binary coding module 250 in the encoder, corresponding motion compensation, inverse transform, and frame reconstruction operations can be performed to obtain the reconstructed frame \hat{x}ₜ.

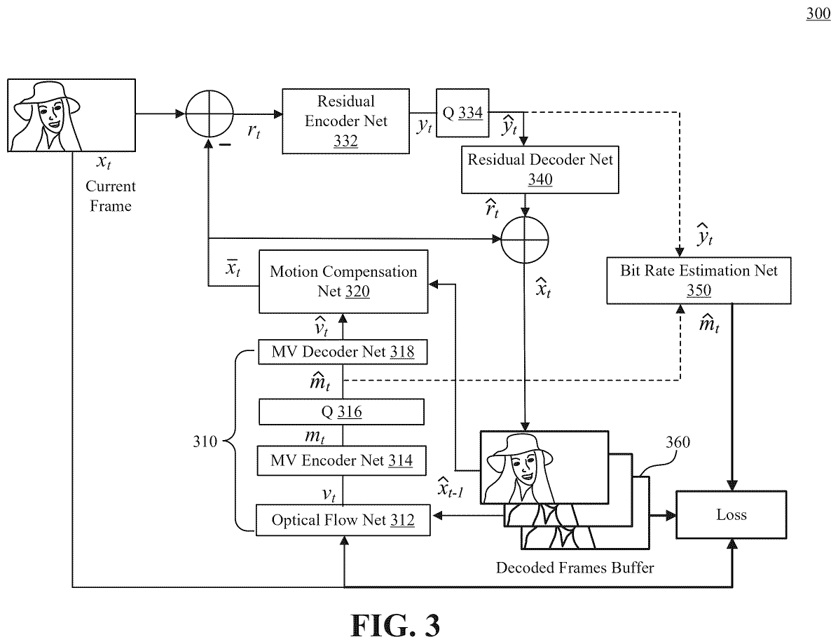

Next, end-to-end Deep-based Video Compression (DVC) techniques are described. FIG. 3 is a schematic diagram illustrating an example architecture of an end-to-end Deep-based Video Compression (DVC) framework 300, according to some embodiments of the present disclosure.

With the development of deep learning, numerous deep-learning-based algorithms can be introduced to replace or enhance video coding tools, including intra/inter prediction, entropy coding and in-loop filtering.

The video compression framework 300 shown in FIG. 3 employs an end-to-end video compression deep model that can jointly optimize some or all components for the video compression, such as motion estimation, motion compression, and residual compression. Specifically, a learning-based optical flow estimation can be utilized to obtain the motion information and reconstruct the current frames. Then two auto-encoder style neural networks are employed to compress the corresponding motion and residual information. The modules can be jointly learned through a single loss function, in which the modules collaborate with each other by considering the trade-off between reducing the number of compression bits and improving the quality of the decoded video. There is one-to-one correspondence between the video compression framework 200 shown in FIG. 2 and the end-to-end deep-based video compression framework 300 shown in FIG. 3, and the relationship and differences between the two frameworks 200 and 300 will be discussed below.

In the framework 300, a motion estimation and compression module 310 includes an optical flow network 312, a motion vector (MV) encoder network 314, a quantization module 316, and a motion vector (MV) decoder network 318. The optical flow network 312 can be a convolutional neural network (CNN) model configured to estimate the optical flow, which is considered as motion information vₜ. Instead of directly encoding the raw optical flow values, the MV encoder network 314 and the MV decoder network 318 are respectively configured to compress and decode the optical flow values, in which the motion representation outputted by the MV encoder network 314 is denoted as mt, and a quantized motion representation outputted by the quantization module 316 is denoted as mt. Then the corresponding reconstructed motion information \hat{v}ₜ can be decoded by using the MV decoder network 318 according to the quantized motion representation \hat{m}ₜ.

For the motion compensation process, a motion compensation network 320 is designed to obtain the predicted frame x̅ₜ based on the reconstructed motion information \hat{v}ₜ.

For the transform and quantization process, the linear transform in the video compression framework 200 in FIG. 2 is replaced by a highly non-linear residual encoder-decoder network, and the residual rₜ is non-linearly mapped to the representation yₜ by a residual encoder network 332. Then, the output yₜ is quantized by a quantization module 334 to obtain the quantized representation ŷₜ. In some embodiments, in order to build an end-to-end training scheme, a quantization method can be used. Then, the quantized representation ŷₜ is fed into a residual decoder network 340 to obtain the reconstructed residual ft.

During the entropy coding stage, at a testing stage, the quantized motion representation \hat{m}ₜ and the residual representation ŷₜ are coded into bits by a bit rate estimation network 350 and sent to the decoder. At a training stage, to estimate the number of bits cost, the CNNs can be used to obtain the probability distribution of each symbol in \hat{m}ₜ and ŷₜ.

The frame reconstruction process and the buffer 360 used in the frame reconstruction process in the framework 300 in FIG. 3 is the same as the frame reconstruction process and the buffer 260 in the framework 200 in FIG. 2, and thus detailed discussions are omitted herein for the sake of brevity.

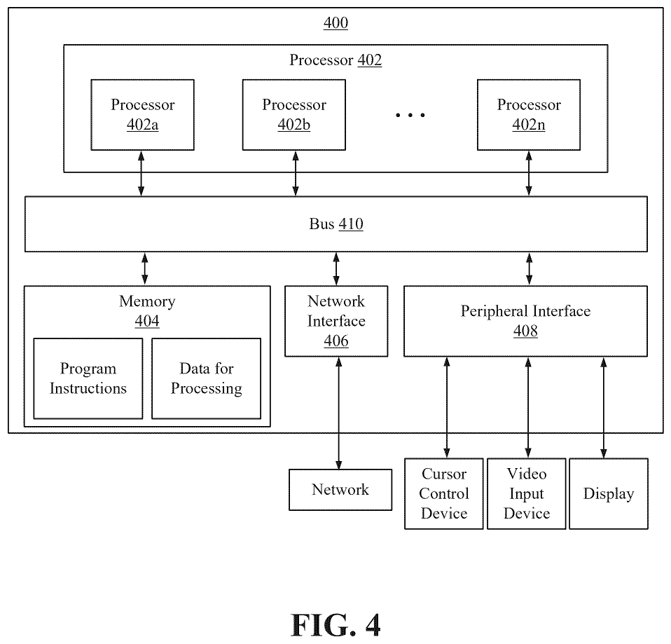

FIG. 4 is a block diagram of an example apparatus 400 for encoding or decoding image data, according to some embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes in the framework 200 or the framework 300) and data for processing (e.g., video sequence, video bitstream, or video stream). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processors 402a-402n and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process in the framework 200 or the framework 300) can be implemented as any combination of any software or hardware modules in apparatus 400. For example, some or all stages of process in the framework 200 or the framework 300 can be implemented as one or more software modules of apparatus 400, such as program instructions that can be loaded into memory 404. For another example, some or all stages of process in the framework 200 or the framework 300 can be implemented as one or more hardware modules of apparatus 400, such as a specialized data processing circuit (e.g., an FPGA, an ASIC, an NPU, or the like).

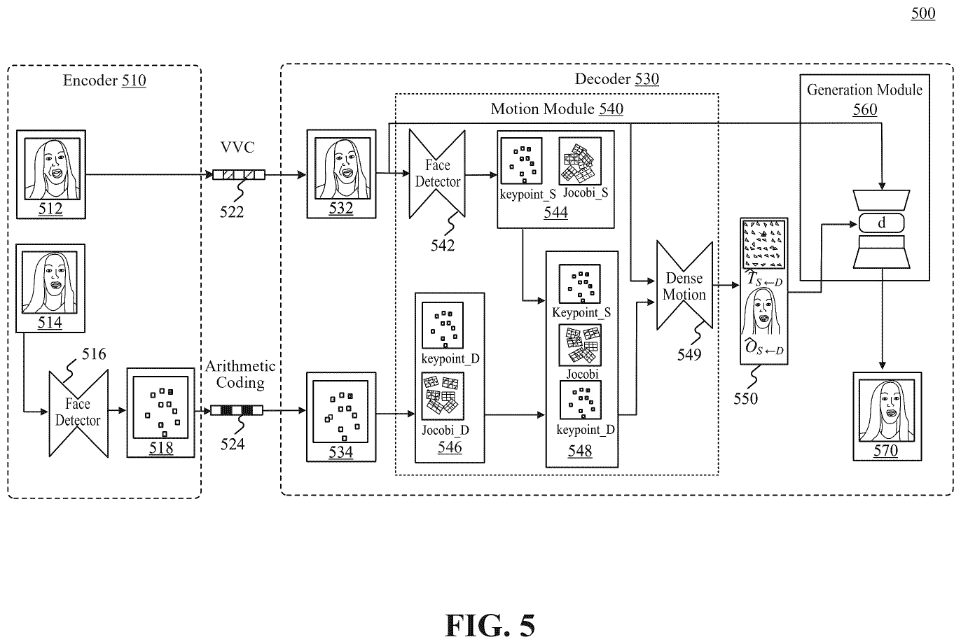

Next, generative video coding consistent with embodiments of the present disclosure will be described. FIG. 5 is a schematic diagram illustrating a basic framework 500 of the deep-based video generative compression scheme based on First Order Motion Model (FOMM), according to some embodiments of the present disclosure.

With the emergence of deep generative models including Variational Auto-Encoding (VAE) and Generative Adversarial Networks (GAN), the facial video compression can achieve promising performance improvement. While various algorithms can realize frame reconstruction with a few facial parameters through the powerful rendering ability of deep generative models, some head posture movements and facial expression movements still fail to be accurately rendered compared with the original moving video.

In the embodiments of FIG. 5, the FOMM deforms a reference source frame to follow the motion of a driving video. This method works on various types of videos and can be used in the face animation application. FOMM follows an encoder-decoder architecture with a motion transfer component.

As shown in FIG. 5, in the framework 500, the encoder 510 is configured to encode a source frame 512 via an image/video compression method, such as HEVC/VVC or JPEG/BPG. In some embodiments, the VVC is used to compress the source frame 512 to obtain a bitstream 522.

As shown in FIG. 5, in the framework 500, the encoder 510 is configured to use a keypoint decoder (e.g., a face detector) 516 to extract motion representation 518 for a driving frame 514, which can be coded by arithmetic coding to obtain a bitstream 524. The decoder 530 is configured to decode the bitstreams 522 and 524 to obtain the reconstructed source frame 532 and the reconstructed motion representation 534. Then, in the motion module 540 in the decoder 530, a keypoint decoder (e.g., a face detector) 542 is configured to process the reconstructed source frame 532 to obtain source frame keypoints information 544. Similarly, the reconstructed motion representation 534 can be used to obtain driving frame keypoints information 546. By combining the source frame keypoints information 544 and the driving frame keypoints information 546, keypoints and local affine transformations 548, including each keypoint and the Jacobians computed in each keypoint location can be obtained. Then, a dense motion network 549 is configured to obtain and output a dense motion field and an occlusion map 550, according to the keypoints and local affine transformations 548.

For example, a keypoint extractor is learned using an equivariant loss, without explicit labels. By this keypoint extractor, two sets of ten learned keypoints are computed for the source and driving frames. The learned keypoints is transformed from the feature map with the size of channel×64×64 via the Gaussian map function, thus every corresponding keypoint can represent different channels' feature information. In the above description, every keypoint is point of (x, y) that can represent the most important information of feature map.

As another example, the dense motion network 549 can use the landmarks and the reconstructed source frame 532 to produce the dense motion field and the occlusion map 550.

Finally, the generation module 560 is configured to output an image 570 of the object. For example, the generation module 560 may include a neural network configured to warp the resulting feature map using the dense motion field by using a differentiable grid-sample operation, and then multiply the warped map with the occlusion map. For example, the generation module 560 may include a generative neural network, also known as a “generator” in a VAE system, a GAN-based system, or a generative face video compression (GFVC) system. The generator can be trained to reconstruct video frames using the reconstructed source frame 532, and the dense motion field and the occlusion map 550. In some embodiments, one or more decoded facial representation parameters can be converted to one or more dense motion flows by the dense motion network 549, and each one of the one or more dense motion flows has a common format that satisfies a requirement of a general generative model of the generator in the generation module 560. In some embodiments, the dense motion network 549 further converts the one or more decoded facial representation parameters to one or more occlusion maps, each one of the one or more occlusion maps has a common format that satisfies a requirement of the general generative model of the generator in the generation module 560. In the FOMM encoder-decoder architecture in FIG. 5, the decoder 530 is configured to generate an image 570 from the warped map by the trained generative neural network in the generation module 560.

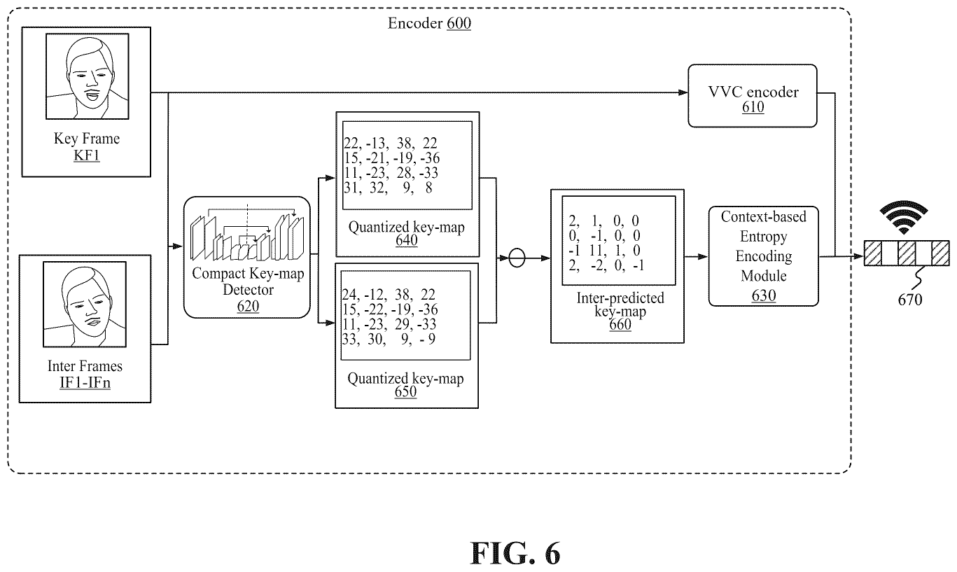

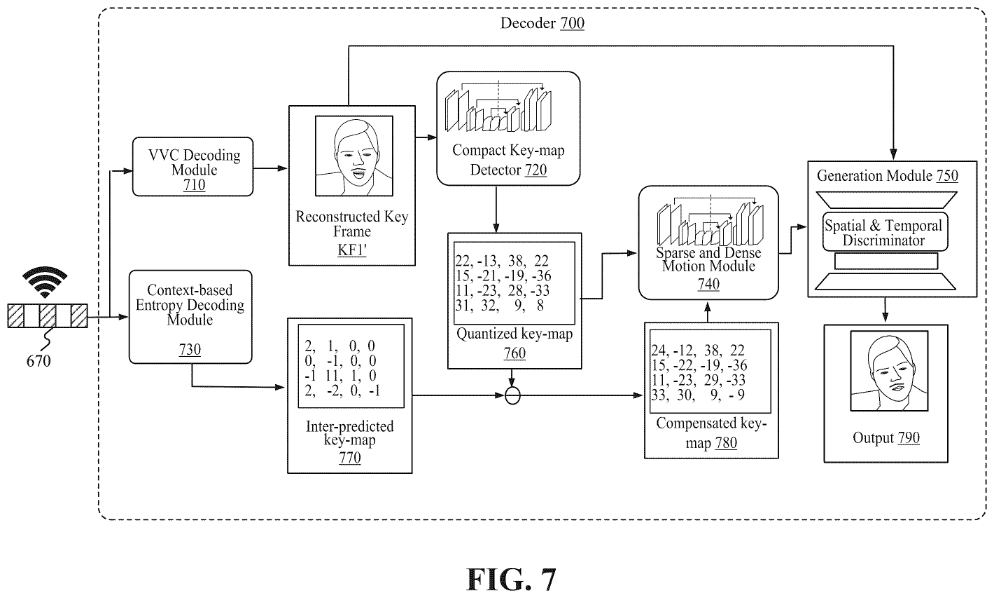

FIG. 6 is a schematic diagram illustrating an encoder 600 of a deep-based video generative compression scheme based on Compact Feature Temporal Evolution (CFTE), according to some embodiments of the present disclosure. FIG. 7 is a schematic diagram illustrating a decoder 700 of a deep-based video generative compression scheme based on Compact Feature Temporal Evolution (CFTE), according to some embodiments of the present disclosure. The framework in FIGS. 6-7 follows an encoder-decoder architecture.

As shown in FIG. 6, at the encoder side, the encoder 600 of the compression framework includes an VVC encoder 610, a feature extractor 620, which can be a compact key-map detector, and a feature coding module 630, which can be a Context-based Entropy Encoding module. The VVC encoder 610 is configured to compress the key frame KF1. The feature extractor 620 is configured to extract the compact human features of the key frame KF1 and the other inter frames IF1-IFn. The feature coding module 630 is configured to compress the inter-predicted residuals of compact human features. First, the key frame KF1 representing the human textures is compressed with the VVC encoder 610. Through the compact feature extractor 620, the key frame KF1 can be represented with a compact feature matrix 640 (e.g., a quantized key-map) with the size of 1×4×4, and each of the subsequent inter frames IF1-IFn can be represented with a compact feature matrix 650 (e.g., a quantized key-map) with the size of 1×4×4. In some embodiments, the size of compact feature matrices 640 and 650 is not fixed and the number of feature parameters can also be increased or decreased according to the specific requirement of bit consumption. Then, these extracted features are inter-predicted and quantized into a residual matrix 660 (e.g., an inter-predicted key-map). Then, the feature coding module 630 is configured to entropy-code the residuals into the bitstream 670.

Moreover, as shown in FIG. 7, at the decoder 700, the compression framework includes an VVC decoder 710, a feature extractor 620, which can be a compact key-map detector, a feature decoding module 730, which can be a Context-based Entropy Decoding module, a sparce and dense motion module 740, and a generation module 750.

The VVC decoder 710 is configured to obtain the reconstructed key frame KF1′ based on the received bitstream 670. The feature extractor 720 is configured to extract the compact human features of the reconstructed key frame KF1′, to obtain the reconstructed compact feature matrix 760 (e.g., a quantized key-map) with the size of 1×4×4. Accordingly, during the generation of the video, the decoded key frame KF1′ from the bitstream 670 can be further represented in the form of features through compact feature extraction. The feature decoding module 730 is configured to output the reconstructed residual matrix 770 (e.g., an inter-predicted key-map) including reconstructed inter-predicted residuals of compact human features. Accordingly, in the reconstruction of the compact features, a reconstructed compact feature matrix 780 (e.g., a compensated key-map) with the size of 1×4×4 for each of the inter frames IF1-IFn can be obtained by entropy decoding and compensation. Subsequently, given the features from the key and inter frames, the sparce and dense motion module 740 is configured to calculate the relevant sparse motion field and facilitate the generation of the pixel-wise dense motion map and occlusion map. Finally, the generation module 750 is configured to, based on the deep generative model, use the decoded key frame, pixel-wise dense motion map and occlusion map with implicit motion field characterization, to produce the final video 790 with accurate appearance, pose, and expression. Accordingly, the final video 790 can be generated by leveraging the reconstructed features and decoded key frame.

Although the above-described generative video compression techniques can achieve promising rate-distortion (RD) performance, there may be associated drawbacks and challenges limiting further performance improvements and practical applications. For example, the flexibility of the generative video codecs may be restricted by feature extraction warping at a fixed feature size, thereby rendering them unable to handle inputs of different resolutions.

In some embodiments of the present disclosure, solutions are provided to solve the one or more of the above-identified problems and challenges associated with generative video compression.

In some embodiments, to further improve the adaptivity and flexibility of generative video coding, a resolution-expandable neural network can dynamically adjust its network width and depth to adapt to inputs of different resolutions. In deep image coding, input images are transformed to latent space for entropy coding. These latents are low-level features with image nuances that are compatible across different sizes. However, in generative video coding, features and motions are high-level information so that one model is normally trained and inferred on single resolution. In some embodiments of the present disclosure, the proposed framework use a more dynamic network structure to achieve more general multi-resolution scalability.

In some embodiments, a resolution-expandable neural network can be used for both foreground generation and background generation. Not to lose generality, the largest possible input resolution is denoted as r, and the number of supported resolutions is denoted as Nₛ. The disclosed resolution-expandable neural network is designed to support multiple resolutions with down-sample factor of k, according to equation (1):

$${r}_{i} ∈ \{ \frac{r}{{k}^{i}} , i = 0 , 1 … {N}_{s} - 1 \} . \qquad ( 1 )$$

Assume there is a down-sample factor s between motions m and input images. During generation, the number of encoder or decoder blocks (depth) in the neural network is N_{B}=log₂ s, to match the size of motions. To handle all resolutions, the width of generation is Nₛ and is no larger than N_{B}.

The key frame reconstruction is down-sampled to features with the same size of foreground motions in the encoder part, and the features are warped by the foreground motions. According to the desired output resolution rᵢ, there are

$${n}_{u} = {log}_{k} s \frac{{r}_{i}}{r}$$

up-sampled blocks in all N_{B} blocks, according to equation (2):

$${F}^{0} = ( {d}_{{N}_{B} - {n}_{u}}^{∘} … {d}_{2}^{∘} {d}_{1}^{∘} {g}_{{n}_{u}}^{∘} … {g}_{2}^{∘} {g}_{1} ( \hat{I} ) ) * m , \qquad ( 2 )$$

where Î denotes reconstructed key frame and m denotes estimated motion flow, * denotes warping operation, and d denotes down-sample block and g denotes normal decoder block that maintain the feature size. Then, after every decoder block, the feature is weighted-summed with warped feature F⁻¹ from the corresponding block of encoder part with corresponding feature size, according to equation (3):

$${F}^{i} = {b}_{i} ( {F}^{i - 1} ) \cdot ( 1 - occ ) + ( {F}^{- i} * m ) \cdot occ , \qquad ( 3 )$$

where bᵢ denotes block that would be up-sample block if i<nᵤ and otherwise would be normal decoder block that maintain the feature size. Finally, the reconstructed interframe can be obtained by activating the last decoder feature with activation function σ, according to equation (4):

$$\hat{P} = σ ( {F}^{{N}_{B}} ) . \qquad ( 4 )$$

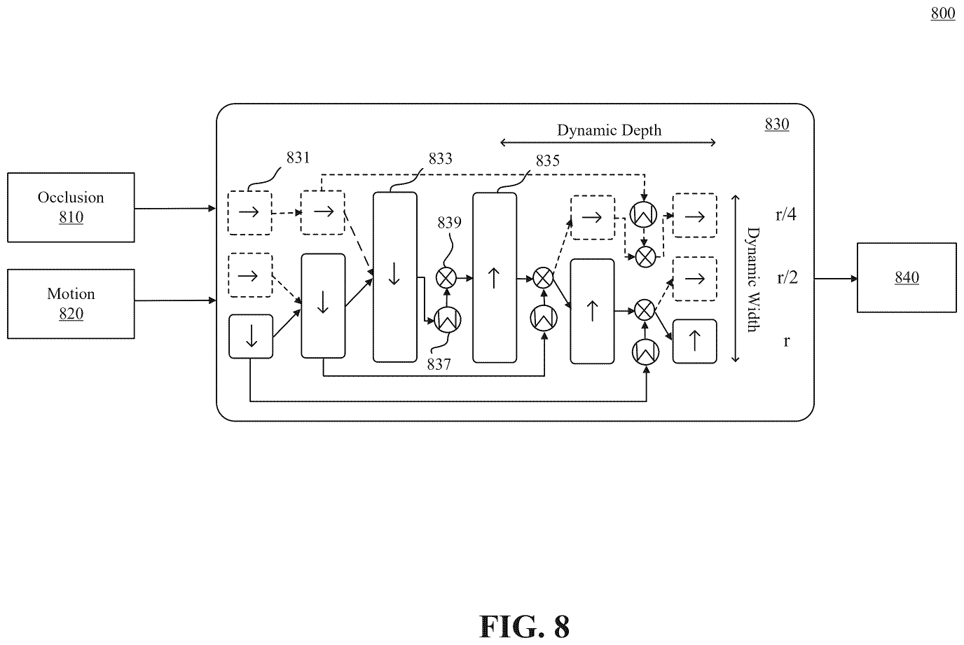

FIG. 8 is a schematic diagram illustrating an example network structure 800 of a resolution-expandable neural network 830, according to some embodiments of the present disclosure. In some embodiments, the neural network 830 is a trained generator, that is, the neural network 830 can be trained, for example, by deep generative models, with a discriminator. In some embodiments, the neural network 830 may be a deep neural network, especially deep generative networks having strong inference capability to reconstruct realistic images. The trained generator can take the dense motion flows (e.g., motion map 820) and occlusion maps (e.g., occlusion map 810) as the inputs and reconstruct the frames (e.g., reconstructed frames 840), such as face frames. The network structure 800 in FIG. 8 provides an example where Nₛ=N_{B}=3. In FIG. 8, the resolution-expandable neural network 830 includes multiple blocks 831 that maintain the feature size, down-sample blocks 833, and multiple up-sample blocks 835, in which “↑” denotes up-sample block, “↓” denotes down-sample block, “→” denotes blocks that maintain the feature size, “w” denotes an operation 837 of warping with a motion map 820, and “x” denotes an operation 839 of masking with an occlusion map 810. The number of decoder blocks in the neural network 830 is log₂s, s being a down-sample factor between the motion information and the reconstructed key frame. In some embodiments, the network width of the neural network 830 is smaller than or equal to the network depth (i.e., the number of encoder or decoder blocks) of the neural network 830.

The network structure 800 can be automatically initialized according to the depth and width setting. For example, the network depth in FIG. 8 is set as 3. And assuming the network width is configured to be 1, only modules with solid outline will be initialized. Assuming the network width is configured to be 3, all modules in FIG. 8 will be initialized. Accordingly, the resolution-expandable neural network 830 can dynamically adapt its network depth and width to inputs of different resolutions, and be configured to obtain the reconstructed frames 840 and produce the final video with accurate appearance, pose, and expression. As described above, the resolution-expandable neural network 830 can be configured to support multiple resolutions R₀-R_{N-1}, in which Rᵢ is defined by R/kⁱ, R is a largest input resolution, k is a down-sample factor, and N is the number of the resolutions. The number of supported resolutions can be realized by adjusting the number of encoder or decoder blocks and the network width. Accordingly, inputs of different resolutions will go through different routes in the resolution-expandable neural network 830 to maintain its resolution for the reconstruction.

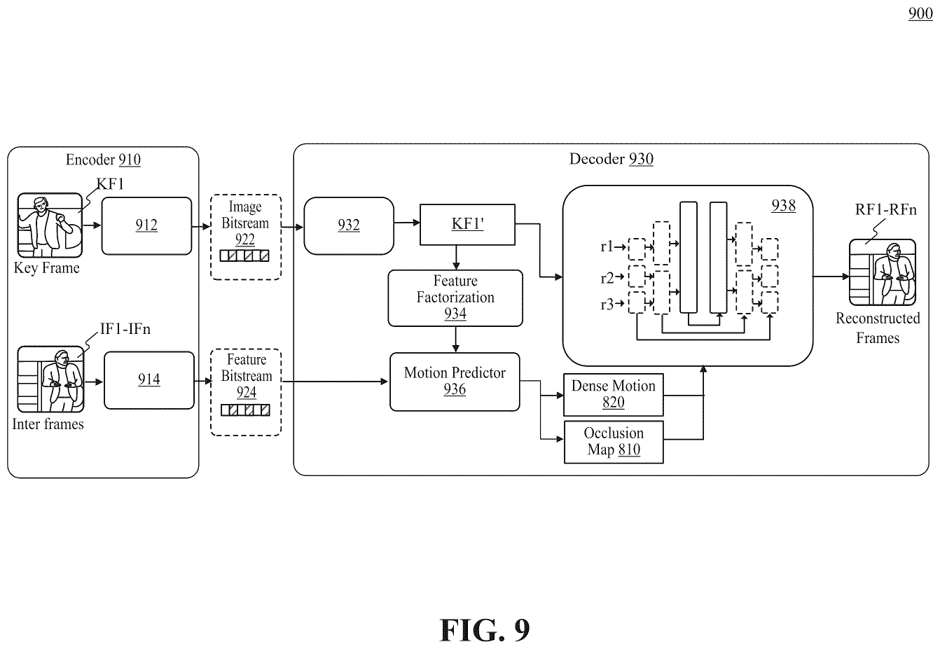

FIG. 9 is a schematic diagram illustrating an example generative video coding system 900 with a resolution-expandable neural network 938, according to some embodiments of the present disclosure. As shown in FIG. 9, the generative video coding system 900 includes an encoder 910 and a decoder 920. Each of the encoder 910 and decoder 920 can be implemented as one or more software or hardware components of an apparatus (e.g., apparatus 400 in FIG. 4).

Referring back to FIG. 9, in some embodiments, the encoder 910 includes an encoding module 912 (e.g., using VVC codec) configured to encode and output an image bitstream 922 including coded information for a key frame KF1 of the video sequence, and a feature factorization module 914 configured to obtain extracted features and encode a feature bitstream 924 including coded information for extracted features of one or more inter frames IF1-IFn of the video sequence.

In some embodiments, the decoder 920 includes a decoding module 932, a feature factorization module 934, a motion predictor 936, and a resolution-expandable neural network 938. In some embodiments, the resolution-expandable neural network 938 can be implemented by the resolution-expandable neural network 830 shown in FIG. 8. The decoding module 932 (e.g., using VVC codec) is configured to decode the image bitstream 922 to reconstruct the key frame and obtain the reconstructed key frame KF1′. The feature factorization module 934 is configured to obtain extracted features of the reconstructed key frame KF1′. The motion predictor 936 is configured to obtain motion information (e.g., pixel-wise dense motion map 820) and occlusion information (e.g., occlusion map 810) based on the extracted features of the reconstructed key frame KF1′ and the extracted features of the one or more inter frames IF1-IFn. Accordingly, the resolution-expandable neural network 938 can be configured to, based on the deep generative model, use the reconstructed key frame KF1′, the pixel-wise dense motion map 820 and the occlusion map 810 with implicit motion field characterization, to obtain the reconstructed frames RF1-RFn and produce the final video with accurate appearance, pose, and expression.

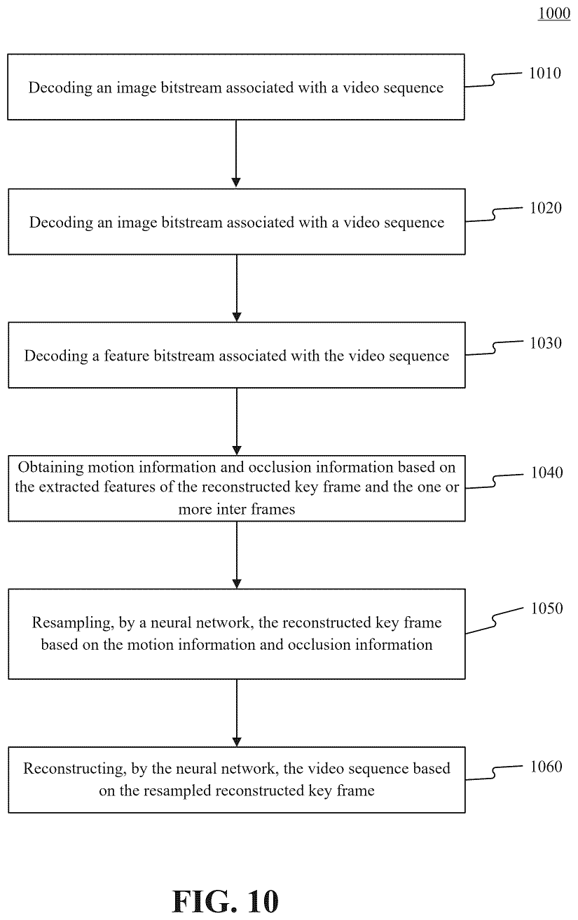

FIG. 10 is a flowchart for an example method 1000 for decoding a bitstream, according to some embodiments of the present disclosure. The method 1000 can be performed by a decoder to decode a video bitstream. For example, the decoder can be implemented as one or more software or hardware components of an apparatus (e.g., apparatus 400 in FIG. 4) for decoding the bitstream (e.g., image bitstream 922 and feature bitstream 924 in FIG. 9) to reconstruct a video frame or a video sequence of the bitstream. For example, a processor (e.g., processor 402 in FIG. 4) can perform the method 1000. As shown in FIG. 10, the method 1000 includes the following steps 1010-1050.

At step 1010, the decoder receives an image bitstream (e.g., image bitstream 922 in FIG. 9) and a feature bitstream 924 (e.g., feature bitstream 924 in FIG. 9) associated with a video sequence. The bitstreams received from the encoder side include coded information associated with a key frame and one or more inter frames following the key frame in a video sequence.

In steps 1020-1080, after receiving the bitstreams, the decoder may decode the bitstreams to output a video sequence. At step 1020, after receiving the bitstreams, the decoder may decode the image bitstream to reconstruct a key frame of the video sequence and obtain extracted features of the reconstructed key frame.

At step 1030, after receiving the bitstreams, the decoder may decode the feature bitstream to obtain extracted features of one or more inter frames of the video sequence.

At step 1040, the decoder may obtain motion information (e.g., pixel-wise dense motion map 820 in FIG. 9) and occlusion information (e.g., occlusion map 810 in FIG. 9) based on the extracted features of the reconstructed key frame and the extracted features of the one or more inter frames.

At step 1050, the decoder may resample, by a neural network (e.g., resolution-expandable neural network 938 in FIG. 9), the reconstructed key frame based on the motion information and occlusion information. A network width and a network depth of the neural network used in step 1050 is adjusted in response to an input resolution. Then, at step 1060, the decoder may reconstruct the video sequence based on the resampled reconstructed key frame.

In some embodiments, at steps 1050 and 1060, the decoder may down-sample the reconstructed key frame to obtain down-sampled features with the same size of a foreground motion, warp the down-sampled features by the foreground motion to obtain warped features; and generate a weighted sum of the warped features used for obtaining reconstructed one or more inter frames.

In some embodiments, at steps 1050, the decoder may perform down-sampling by one or more down-sample blocks (e.g., down-sample blocks 833 in FIG. 8) of the neural network, and perform up-sampling by one or more up-sample blocks (e.g., up-sample blocks 835 in FIG. 8) of the neural network. In some embodiments, the neural network may dynamically adjust the network width and the network depth of the neural network to adapt to inputs of the neural network with different resolutions, so that inputs with different resolutions can go through different routes in the neural network to maintain the resolution for reconstruction.

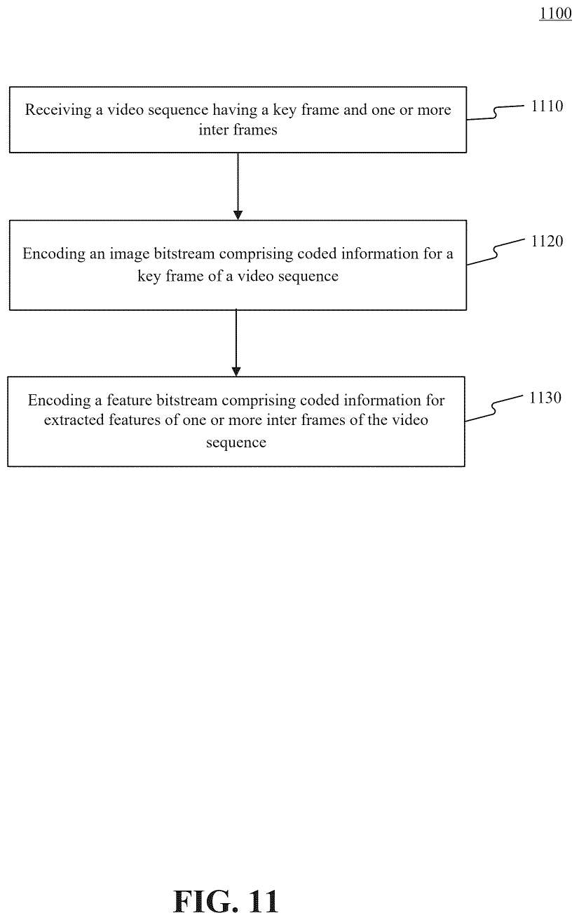

FIG. 11 is a flowchart for an example method 1100 for encoding a bitstream, according to some embodiments of the present disclosure. The method 1100 can be performed by an encoder to encode a video bitstream. For example, the encoder can be implemented as one or more software or hardware components of an apparatus (e.g., apparatus 400 in FIG. 4) for encoding the bitstream (e.g., image bitstream 922 and feature bitstream 924 in FIG. 9) for reconstructing a video frame or a video sequence. For example, a processor (e.g., processor 402 in FIG. 4) can perform the method 1100. As shown in FIG. 11, the method 1100 includes the following steps 1110, 1120 and 1130.

At step 1110, the encoder receives a video sequence having a key frame (e.g., key frame KF1 in FIG. 9) and one or more inter frames (e.g., inter frames IF1-IFn in FIG. 9) following the key frame, and classifies the key frame and the one or more inter frames.

At step 1120, the encoder may encode an image bitstream (e.g., image bitstream 922 in FIG. 9) having coded information for the key frame. The image bitstream is decodable to reconstruct the key frame. In some embodiments, the encoder includes an encoding module using VVC codec to encode and output the image bitstream.

At step 1130, the encoder may encode a feature bitstream (e.g., feature bitstream 924 in FIG. 9) having coded information for extracted features of the one or more inter frames. In some embodiments, the encoder may use a feature factorization module to obtain extracted features and encode the feature bitstream including coded information for extracted features of the one or more inter frames.

During the decoding process, the features of the reconstructed key frame and the features of the one or more inter frames encoded in the feature bitstream are used to generate dense motion information and occlusion information for resampling the reconstructed key frame by a neural network. The neural network reconstructs the video sequence by adjusting a network width and a network depth in response to an input resolution. The neural network is configured to support multiple resolutions R₀, . . . , and R_{N-1}, in which Rᵢ is defined by R/kⁱ, R is a largest input resolution, k is a down-sample factor, and N is the number of the resolutions.

In some embodiments, the neural network is configured to dynamically adjust the network width and the network depth to adapt to inputs of the neural network with different resolutions, and the network width of the neural network is smaller than or equal to the network depth of the neural network. For example, the neural network may include log₂s encoder or decoder blocks, s being a down-sample factor between the motion information and the reconstructed key frame. The reconstructed key frame can be resampled by performing down-sampling by one or more down-sample blocks of the neural network, and performing up-sampling by one or more up-sample blocks of the neural network. Accordingly, the reconstructed key frame can be down-sampled to obtain down-sampled features with the same size of a foreground motion. The down-sampled features are warped by the foreground motion to obtain warped features, and a weighted sum of the warped features can be generated and used for obtaining reconstructed one or more inter frames.

In some embodiments, a non-transitory computer-readable storage medium storing an image bitstream and a feature bitstream is also provided. The image bitstream and the feature bitstream can be encoded and decoded according to the disclosed resolution-expandable neural network for generative video compression.

As explained above, an image bitstream and a feature bitstream can be generated based on a video sequence. The image bitstream includes coded information for reconstructing a key frame of the video sequence and obtaining extracted features of the reconstructed key frame, and the feature bitstream includes coded information for obtaining extracted features of one or more inter frames of the video sequence. Accordingly, the image bitstream and the feature bitstream can be generated based on an input video sequence, and stored in at least one non-transitory computer-readable storage medium. The video sequence is to be reconstructed by a neural network that resamples the reconstructed key frame, and the neural network adjusts a network width and a network depth in response to an input resolution.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:

1. A video decoding method, comprising:
decoding an image bitstream associated with a video sequence to reconstruct a key frame of the video sequence and obtain extracted features of the reconstructed key frame;
decoding a feature bitstream associated with the video sequence to obtain extracted features of one or more inter frames of the video sequence;
obtaining motion information and occlusion information based on the extracted features of the reconstructed key frame and the extracted features of the one or more inter frames;
resampling, by a neural network, the reconstructed key frame based on the motion information and occlusion information; and
reconstructing, by the neural network, the video sequence based on the resampled reconstructed key frame, wherein a network width and a network depth of the neural network is adjusted in response to an input resolution.

2. The video decoding method according to clause 1, wherein resampling the reconstructed key frame comprises:
down-sampling the reconstructed key frame to obtain down-sampled features with a same size of a foreground motion;
warping the down-sampled features by the foreground motion to obtain warped features; and
generating a weighted sum of the warped features, wherein the weighted sum is used for obtaining reconstructed one or more inter frames.

3. The video decoding method according to clause 1 or 2, further comprising:
dynamically adjusting the network width and the network depth of the neural network to adapt to inputs of the neural network with different resolutions.

4. The video decoding method according to any of clauses 1-3, wherein the neural network is configured to support a plurality of resolutions R0, . . . , and RN-1, wherein Ri is defined by R/ki, R being a largest input resolution, k being a down-sample factor, and N being the number of the resolutions.

5. The video decoding method according to any of clauses 1-4, wherein the neural network comprises log 2s decoder blocks, s being a down-sample factor between the motion information and the reconstructed key frame.

6. The video decoding method according to any of clauses 1-5, wherein the network width of the neural network is smaller than or equal to the network depth of the neural network.

7. The method of any of clauses 1-6, wherein resampling the reconstructed key frame comprises:
performing down-sampling by one or more down-sample blocks of the neural network; and
performing up-sampling by one or more up-sample blocks of the neural network.

8. A video encoding method, comprising:
encoding an image bitstream comprising coded information for a key frame of a video sequence, wherein the image bitstream is decodable to reconstruct the key frame; and
encoding a feature bitstream comprising coded information for extracted features of one or more inter frames of the video sequence,
wherein features of a reconstructed key frame and the features of the one or more inter frames encoded in the feature bitstream are used to generate dense motion information and occlusion information for resampling the reconstructed key frame by a neural network,
wherein the neural network reconstructs the video sequence by adjusting a network width and a network depth in response to an input resolution.

9. The video encoding method according to clause 8, wherein the reconstructed key frame is resampled by:
down-sampling the reconstructed key frame to obtain down-sampled features with a same size of a foreground motion;
warping the down-sampled features by the foreground motion to obtain warped features; and
generating a weighted sum of the warped features, wherein the weighted sum is used for obtaining reconstructed one or more inter frames.

10. The video encoding method according to clause 8 or 9, wherein the neural network is configured to dynamically adjust the network width and the network depth to adapt to inputs of the neural network with different resolutions.

11. The video encoding method according to any of clauses 8-10, wherein the neural network is configured to support a plurality of resolutions R0, . . . , and RN-1, wherein Ri is defined by R/ki, R being a largest input resolution, k being a down-sample factor, and N being the number of the resolutions.

12. The video encoding method according to any of clauses 8-11, wherein the neural network comprises log 2s blocks, s being a down-sample factor between the motion information and the reconstructed key frame.

13. The video encoding method according to any of clauses 8-12, wherein the network width of the neural network is smaller than or equal to the network depth of the neural network.

14. The video encoding method according to any of clauses 8-13, wherein the reconstructed key frame is resampled by performing down-sampling by one or more down-sample blocks of the neural network, and performing up-sampling by one or more up-sample blocks of the neural network.

15. A method of storing an image bitstream and a feature bitstream, the method comprising:
generating an image bitstream and a feature bitstream based on a video sequence, wherein the image bitstream comprises coded information for reconstructing a key frame of the video sequence and obtaining extracted features of the reconstructed key frame, and the feature bitstream comprises coded information for obtaining extracted features of one or more inter frames of the video sequence; and
storing the image bitstream and the feature bitstream in at least one non-transitory computer-readable medium,
wherein the video sequence is to be reconstructed by a neural network that resamples the reconstructed key frame, the neural network adjusting a network width and a network depth in response to an input resolution.

16. The method according to clause 15, wherein the reconstructed key frame is resampled by:
down-sampling the reconstructed key frame to obtain down-sampled features with a same size of a foreground motion;
warping the down-sampled features by the foreground motion to obtain warped features; and
generating a weighted sum of the warped features, wherein the weighted sum is used for obtaining reconstructed one or more inter frames.

17. The method according to clause 15 or 16, wherein the neural network is configured to dynamically adjust the network width and the network depth to adapt to inputs of the neural network with different resolutions.

18. The method according to any of clauses 15-17, wherein the neural network is configured to support a plurality of resolutions R0, . . . , RNs-1, wherein Ri is defined by R/ki, R being a largest input resolution, k being a down-sample factor, and Ns being the number of the resolutions.

19. The method according to any of clauses 15-18, wherein the reconstructed key frame is resampled by:
performing down-sampling by one or more down-sample blocks of the neural network; and
performing up-sampling by one or more up-sample blocks of the neural network.

20. The method according to any of clauses 15-19, wherein the network width of the neural network is smaller than or equal to the network depth of the neural network.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments, and the embodiments described in the present disclosure can be freely combined. Accordingly, although specific terms are employed, they are used in a generic and descriptive sense only and not for purposes of limitation.

What is claimed is:

1. A video decoding method, comprising:
decoding an image bitstream associated with a video sequence to reconstruct a key frame of the video sequence and obtain extracted features of the reconstructed key frame;
decoding a feature bitstream associated with the video sequence to obtain extracted features of one or more inter frames of the video sequence;
obtaining motion information and occlusion information based on the extracted features of the reconstructed key frame and the extracted features of the one or more inter frames;
resampling, by a neural network, the reconstructed key frame based on the motion information and occlusion information; and
reconstructing, by the neural network, the video sequence based on the resampled reconstructed key frame, wherein a network width and a network depth of the neural network is adjusted in response to an input resolution.

2. The video decoding method according to claim 1, wherein resampling the reconstructed key frame comprises:
down-sampling the reconstructed key frame to obtain down-sampled features with a same size of a foreground motion;
warping the down-sampled features by the foreground motion to obtain warped features; and
generating a weighted sum of the warped features, wherein the weighted sum is used for obtaining reconstructed one or more inter frames.

3. The video decoding method according to claim 1, further comprising:
dynamically adjusting the network width and the network depth of the neural network to adapt to inputs of the neural network with different resolutions.

4. The video decoding method according to claim 1, wherein the neural network is configured to support a plurality of resolutions R₀, . . . , and R_{N-1}, wherein Rᵢ is defined by R/kⁱ, R being a largest input resolution, k being a down-sample factor, and N being the number of the resolutions.

5. The video decoding method according to claim 1, wherein the neural network comprises log₂s decoder blocks, s being a down-sample factor between the motion information and the reconstructed key frame.

6. The video decoding method according to claim 1, wherein the network width of the neural network is smaller than or equal to the network depth of the neural network.

7. The method of claim 1, wherein resampling the reconstructed key frame comprises:
performing down-sampling by one or more down-sample blocks of the neural network; and
performing up-sampling by one or more up-sample blocks of the neural network.

8. A video encoding method, comprising:
encoding an image bitstream comprising coded information for a key frame of a video sequence, wherein the image bitstream is decodable to reconstruct the key frame; and
encoding a feature bitstream comprising coded information for extracted features of one or more inter frames of the video sequence,
wherein features of a reconstructed key frame and the features of the one or more inter frames encoded in the feature bitstream are used to generate dense motion information and occlusion information for resampling the reconstructed key frame by a neural network,
wherein the neural network reconstructs the video sequence by adjusting a network width and a network depth in response to an input resolution.

9. The video encoding method according to claim 8, wherein the reconstructed key frame is resampled by:
down-sampling the reconstructed key frame to obtain down-sampled features with a same size of a foreground motion;
warping the down-sampled features by the foreground motion to obtain warped features; and
generating a weighted sum of the warped features, wherein the weighted sum is used for obtaining reconstructed one or more inter frames.

10. The video encoding method according to claim 8, wherein the neural network is configured to dynamically adjust the network width and the network depth to adapt to inputs of the neural network with different resolutions.

11. The video encoding method according to claim 8, wherein the neural network is configured to support a plurality of resolutions R₀, . . . , and R_{N-1}, wherein Rᵢ is defined by R/kⁱ, R being a largest input resolution, k being a down-sample factor, and N being the number of the resolutions.

12. The video encoding method according to claim 8, wherein the neural network comprises log₂s blocks, s being a down-sample factor between the motion information and the reconstructed key frame.

13. The video encoding method according to claim 8, wherein the network width of the neural network is smaller than or equal to the network depth of the neural network.

14. The video encoding method according to claim 8, wherein the reconstructed key frame is resampled by performing down-sampling by one or more down-sample blocks of the neural network, and performing up-sampling by one or more up-sample blocks of the neural network.

15. A method of storing an image bitstream and a feature bitstream, the method comprising:
generating an image bitstream and a feature bitstream based on a video sequence, wherein the image bitstream comprises coded information for reconstructing a key frame of the video sequence and obtaining extracted features of the reconstructed key frame, and the feature bitstream comprises coded information for obtaining extracted features of one or more inter frames of the video sequence; and
storing the image bitstream and the feature bitstream in at least one non-transitory computer-readable medium,
wherein the video sequence is to be reconstructed by a neural network that resamples the reconstructed key frame, the neural network adjusting a network width and a network depth in response to an input resolution.

16. The method according to claim 15, wherein the reconstructed key frame is resampled by:
down-sampling the reconstructed key frame to obtain down-sampled features with a same size of a foreground motion;
warping the down-sampled features by the foreground motion to obtain warped features; and
generating a weighted sum of the warped features, wherein the weighted sum is used for obtaining reconstructed one or more inter frames.

17. The method according to claim 15, wherein the neural network is configured to dynamically adjust the network width and the network depth to adapt to inputs of the neural network with different resolutions.

18. The method according to claim 15, wherein the neural network is configured to support a plurality of resolutions R₀, . . . , R_{Ns-1}, wherein Rᵢ is defined by R/kⁱ, R being a largest input resolution, k being a down-sample factor, and Nₛ being the number of the resolutions.

19. The method according to claim 15, wherein the reconstructed key frame is resampled by:
performing down-sampling by one or more down-sample blocks of the neural network; and
performing up-sampling by one or more up-sample blocks of the neural network.

20. The method according to claim 15, wherein the network width of the neural network is smaller than or equal to the network depth of the neural network.
